(19) United States
(12) Patent Application Publication
(10) Pub. No.: US 2005/0050751 A1
(43) Pub. Date: Mar. 10, 2005

(54) Cap conditioner

(76) Inventors: Greg Via, Amherst, NY (US); Dave Aichinger, Cheektowaga, NY (US)

Correspondence Address: Kevin D. McCarthy;Roach Brown McCarthy & Gruber, P.C., 1620 Liberty Building, 420 Main Street, Buffalo, NY, 14202, US

(21) Appl. No.: 10/867,980

(22) Filed: Jun. 15, 2004

Related U.S. Application Data
(60) Provisional application No. 60/486,472, filed on Jul. 11, 2003.

(51) Int. Cl. F26B 19/00; B67D 5/64

(52) U.S. Cl. 34/90

(57) ABSTRACT

The present invention is directed to a portable apparatus comprising at least a fan and an outlet conduit. The fan draws ambient air through an inlet and directs the air to the outlet conduit. The outlet conduit has a proximal end and a distal end. At or near the distal end is at least one aperture. A hat is placed over the aperture and distal end; or a brim of a baseball hat is positioned within the aperture. If the hat is over the aperture and distal end when air exhausts from the aperture, the hat hovers over the distal end. Optionally, the distal end's outer perimeter can expand or contract to the desired size of the hat. Also, the apparatus can have additional components that cool and/or heat the ambient air. The user of the device can also cleanse the hat by applying conventional hat that allows the air to In particular, the outlet is designed to have a baseball-like cap capable of being dried, cleansed, cooled, heated and/or re-shaped when the baseball-like cap is placed over the outlet and the at least one aperture.

### CLAIM OF PRIORITY

This application claims priority to U.S. provisional patent application Ser. No. 60/486,472, which was filed on Jul. 11, 2003.

### FIELD OF THE INVENTION

The present invention is directed to an apparatus for conditioning a hat.

### BACKGROUND OF THE INVENTION

It is well known that individuals do not like to wear wet and/or sweaty apparel. Numerous patents have been obtained to address this problem. As a matter of fact, this problem appears to be a continuous problem. We have this opinion because we have noticed that patents that address this issue have been issued since at least as early as 1920.

These patents have created apparatuses for drying ski boots, gloves, suits, socks, garments, and shoes. And at least one patent discloses an apparatus for stretching, forming, and drying gloves and the like. See U.S. Pat. Nos. 1,475,193 (Meehan); 2,565,455 (Miller et al); 3,645,009 (Ketchum); 4,085,519 (Masika); 5,016,364 (Cochrane); 1,450,033 (Gowan); 4,094,076 (Baslow); 1,338,031 (Messinger); 2,668,368 (Jacobs); 2,614,337 (Darbo); and 5,379,525 (Raynor). None of those patents disclose, teach, or suggest a compact, possibly portable, apparatus for drying, cooling, re-shaping, and/or cleaning a baseball hat made of a cloth material.

A quality baseball hat, like the ones made by New Era Cap Co., Inc., and worn by Major League Baseball players, is made of a fabric and sewed together. After the hat is sewn together, the hat is placed on a de-wrinkle machine. The de-wrinkle machine has a steaming blockhead and a steam source. The steam source provides steam to the blockhead. The blockhead allows the steam to penetrate there through. Each blockhead is also sized for a particular hat size. The user of the de-wrinkle machine places a hat of a particular size onto a blockhead for certain sized hat. When the steam penetrates through the blockhead, the steam essentially removes the wrinkles from the fabric of the hat. An unwrinkled cap is, hopefully, better for sales of the cap.

In addition, the brim of the hat can be inserted into a brim shaper device. The brim shaper device has a pre-defined aperture to alter a hat brim to an alternative, and possibly, desired shape and a steam source. The steam source provides steam to the pre-defined aperture. The pre-defined aperture receives the brim of a hat. Once the steam is within the pre-defined aperture, the steam allows the brim to easily form into the desired shape of the pre-defined aperture. Again this device allows the hat to obtain a desired brim shape.

The above-identified brim shaper device and de-wrinkle machine are standard units used during the manufacturing process of baseball hats. These units are large devices that use a lot of space. Moreover, each device is designed for a specific task and no more. That means, these large devices are not used by individuals own and wear the hats.

On a warm day, the sweat can pour from your head. When an individual wears a hat, that sweat, which is salty, is absorbed into the bill of the hat and the fabric of the hat. After such perspiration, the hat may become undesirable to put back on and look unattractive if extensive sweat stains are thereon.

At “http://www.howtocleananything.com/hca_tip_listing ByCategory.asp?Category=Recreation&SubCategory=All” (there is no spacing at “ . . . listingByCategory . . . ”, but there was no other way to provide the internet address in this application), there is a disclosure on how to clean baseball caps. The disclosure reads as follows:
Tools & Chemicals: Laundry pre-treat or laundry soap.
Technique: Baseball caps are easy just pre-spray the headband with laundry pre treat or use liquid laundry soap and rub it on the head band and throw in the wash with your laundry. The trick is to be sure to take it out right after the rinse. Reshape the hat and let air dry. Do NOT dry in the dryer this will damage the hat for sure. If you have a hat you are really fond of and want to be even more careful you can buy a product which is designed to go into the dishwasher (it is a rubberized steel rack the shape of a baseball cap) and you can wash the cap in the dishwasher using dishwasher soap on the delicate cycle, again air drying once the rinse is finished.
   That method is acceptable for cleaning hats, but not acceptable for professional and accomplished amateur athletes who wear baseball hats during an activity and/or the sidelines. Examples of such athletic activities include and are not limited to baseball, golf, tennis, football, soccer, musical, theatrical, cricket, track and field, fashion statements, and any place that baseball hats are worn. When hats obtain sweat bands, the hats can become unappealing to others and the wearer. The present invention allows the hat to be cleaned, de-sweated, and heated on an expeditious basis to allow the wearer the opportunity to continue wearing a favorite and/or desired hat.

The present invention solves these problems.

### SUMMARY OF THE INVENTION

The present invention is directed to a portable apparatus comprising at least a fan and an outlet conduit. The fan draws ambient air through an inlet and directs the air to the outlet conduit. The outlet conduit has a proximal end and a distal end. At or near the distal end is at least one aperture. A hat is placed over the aperture and distal end; or a brim of a baseball hat is positioned within the aperture. If the hat is over the aperture and distal end when air exhausts from the aperture, the hat hovers over the distal end. Optionally, the distal end's outer perimeter can expand or contract to the desired size of the hat. Also, the apparatus can have additional components that cool and/or heat the ambient air. The user of the device can also cleanse the hat by applying conventional hat that allows the air to In particular, the outlet is designed to have a baseball-like cap capable of being dried, cleansed, cooled, heated and/or re-shaped when the baseball-like cap is placed over the outlet and the at least one aperture.

### BRIEF DESCRIPTION OF THE DRAWINGS

FIG. 1a illustrates an isometric view of the present invention.

FIG. 1b illustrates a cross-sectional view of line 1-1 from FIG. 1a.

FIG. 1c illustrates an electrical schematic of FIG. 1a.

FIG. 2 illustrates an alternative outlet in relation to FIG. 1a.

FIG. 3 illustrates a schematic of a second alternative embodiment of FIG. 1a.

FIG. 4 illustrates an alternative operation of the outlet of FIG. 1a.

### DETAILED DESCRIPTION OF THE PRESENT INVENTION

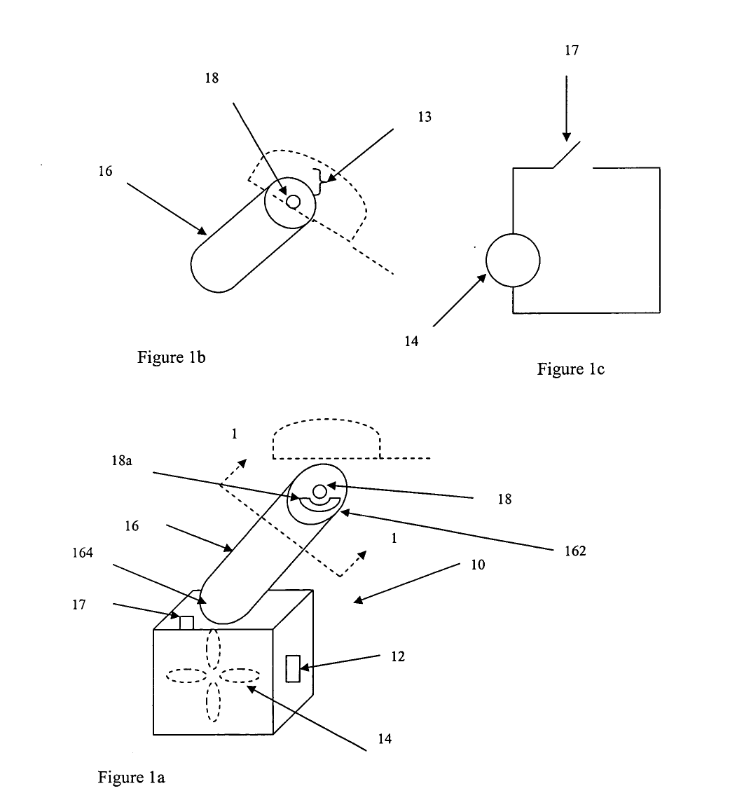

A first embodiment of the present invention is illustrated at FIG. 1a. In FIG. 1a, a container 10 is illustrated having an inlet 12, a fan 14, and an outlet conduit 16. In FIG. 1b the electrical schematic of FIG. 1a is illustrated. The fan 14, which is operated through switch 17, is a conventional fan that draws air from the ambient environment into the inlet 12 and directs the air into the outlet conduit 16. The outlet conduit 16 has a distal end 162 and a proximal end 164. The distal end 162 is at least shaped to receive a skull portion of a baseball cap (or alternatively the exterior portion of the skull portion if the hat is turned inside out) and has at least one aperture 18. The at least one aperture 18 allows sufficient air to escape from the outlet conduit 16 to affect the cap that is positioned over the distal end 162. Preferably, the at least one aperture allows sufficient amount of air to escape to have the cap float, see FIG. 1b and gap 13, above the aperture 18 and the distal end 162. By having the cap float, the entire skull portion (or exterior portion of the skull portion) is exposed to the air that allows the hat to lose its undesired sweatiness. That way the hat should be completely dried.

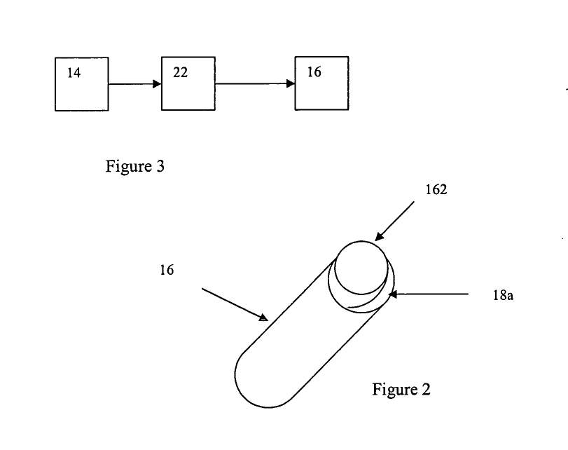

A second embodiment of the present invention is illustrated at FIG. 2. Fundamentally, this second embodiment is identical to the first embodiment except for one thing. The exception is that the at least one aperture 18a is designed to receive the brim of a cap. Like the previous embodiment, the undesired sweatiness that collects on the brim can be effectively removed.

A third embodiment of the present invention is illustrated at FIG. 3. The third embodiment is similar to the first embodiment with one exception. That exception is that the air drawn from the ambient air by the fan 14 is initially directed to a conventional air conditioner unit, a heater unit and/or humidifier unit 22 before being directed to the outlet 16. That way, the cap can be cooled, heated, and/or humidified with clean water. That way, the user can have a hat having a desired clean wetness and/or temperature.

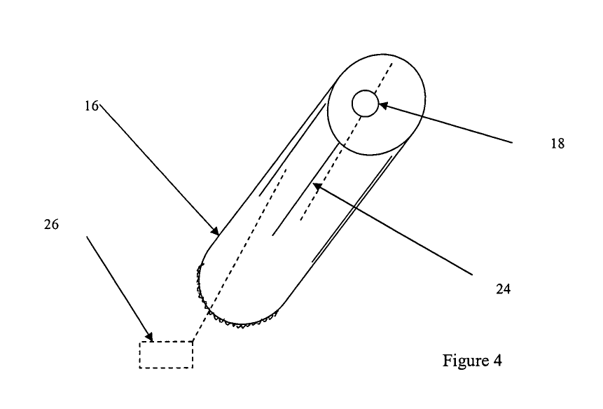

A fourth embodiment of the present invention is illustrated at FIG. 4. The fourth embodiment is similar to the first embodiment with one exception. That exception is that the outlet conduit 16 is adjustable for each and every size of cap. One method to accomplish this objective is to have a slit 24 (or a plurality thereof) in the outlet conduit that allows conventional manual or mechanical operations 26 to adjust, by expansion or contraction, the outlet conduit 16 to a desired hat size that corresponds to the original hat size. This embodiment is useful in case the hat gets too moist or wet. When quality hats get too wet or moist, the quality hats shrink. Such shrinkage may cause headaches. Headaches are undesirable. Accordingly, the hat can be placed on the outlet conduit 16, the outlet conduit 16 can be adjusted to the desired size while providing the desired air (ambient—see FIGS. 1a-c and 2, or cooled or heated—see FIG. 3). That way the hat can be reshaped to desired size expeditiously, desweated, heated, cooled and/or humidified.

A fifth embodiment is any combination of the first four embodiments to create a desired apparatus 10 for drying, humidifying, heating, cooling or re-shaping the hat and/or bill.

In addition, the present invention can be used to remove the salt lines that accrue on the cap after extensive sweating. With the present invention, a conventional cloth hat can have the salt lines removed while retaining the desired shape, not always possible by the prior art method identified above. The user would apply a conventional salt remover composition to the salted fabric and position the hat over the outlet conduit 16. Once properly positioned, the apparatus 10 applies the air at a desired temperature and/or moisture to the hat, and the salt lines should and normally do disappear.

The apparatus 10 is preferably portable. That allows the apparatus 10 to be moved from, for example, a dugout to the locker room. That allows the trainer to move it to desired positions. As with all portable devices, the apparatus 10 can be permanently affixed to a wall or floor. As such, the definition of portable means the apparatus 10, when not affixed, can be easily moved by an ordinary adult male by merely lifting the apparatus 10 by arm strength alone.

While the preferred embodiment of the invention has been illustrated and described, it will be clear that the invention is not so limited. Numerous modifications, changes, variations, substitutions and equivalents will occur to those skilled in the art without departing from the spirit and scope of the present invention as defined by the appended claims.

1. A portable apparatus for making hats look presentable and/or comfortable comprising
a fan that draws ambient air through an inlet and directs that air to an outlet conduit;
the outlet conduit has a distal end and a proximal end, the proximal end receives the air from the fan and directs the air toward the distal end;
at least one aperture is positioned at and/or near the distal end; and
a hat is positioned over the at least one aperture and the portable apparatus alters the condition of the hat to a desired condition.

2. The apparatus of claim 1 wherein the condition of the hat is initially sweaty and the desired condition is significantly decreased sweatiness.

3. The apparatus of claim 2 wherein significantly decreased sweatiness is dry.

4. The apparatus of claim 1 wherein the fan directs the ambient air first to an air altering condition device prior to the air being exhausted out of the at least one aperture.

5. The apparatus of claim 4 wherein the air altering condition device is an air conditioning unit to cool the hat.

6. The apparatus of claim 4 wherein the air altering condition device is an air heater unit to heat the hat.

7. The apparatus of claim 4 wherein the air altering condition device is a humidifier to apply controllable amount of desalinated moisture to the hat.

8. The apparatus of claim 1 wherein the outer perimeter of the outlet conduit is adjustable to the desired size of the hat.

9. The apparatus of claim 1 wherein the at least one aperture is a bill receiving aperture.

10. The apparatus of claim 9 wherein the bill receiving aperture receives a bill of a baseball-like hat.

11. The apparatus of claim 1 wherein the hat is cleaned by applying a cleaning composition on to the hat, and allowing the heated, cooled, humidified or ambient air to be applied to the hat through the aperture.

12. The apparatus of claim 8 wherein the outer perimeter of the outlet conduit adjusted by electrical, pneumatic and/or manual devices.

13. The apparatus of claim 1 wherein the hat floats above the aperture when air is exhausting from the at least one aperture.

14. A method of using a portable apparatus for making hats look presentable and/or comfortable comprising
drawing ambient air through an inlet and directing that air to an outlet conduit by a fan;
directing the air through the outlet conduit, the outlet conduit has a distal end and a proximal end, the proximal end receives the air from the fan and directs the air toward the distal end, at least one aperture is positioned at and/or near the distal end;
receiving a hat over and/or within the distal end so the portable apparatus alters the condition of the hat to a desired condition.

15. A portable apparatus for making hats look presentable and/or comfortable comprising
a fan that draws ambient air through an inlet and directs that air to an outlet conduit;
the outlet conduit has a distal end and a proximal end, the proximal end receives the air from the fan and directs the air toward the distal end;
a first aperture is positioned at or near the distal end, and capable of receiving a bill from a baseball-like hat; and
the hat is positioned above or within the aperture and the portable apparatus alters the condition of the hat to a desired condition.
